(19) United States
(12) Patent Application Publication
(10) Pub. No.: US 2010/0110552 A1
(43) Pub. Date: May 6, 2010

(54) ANTIREFLECTION STRUCTURAL BODY

(75) Inventors: Tatsuhiro Nakazawa, Tokyo (JP); Shigeo Kittaka, Tokyo (JP)

Correspondence Address: HAMRE, SCHUMANN, MUELLER & LARSON, P.C., P.O. BOX 2902, MINNEAPOLIS, MN, 55402-0902, US

(73) Assignee: NIPPON SHEET GLASS COMPANY, LIMITED, Tokyo (JP)

(21) Appl. No.: 12/527,593

(22) PCT Filed: Feb. 22, 2008
(86) PCT No.: PCT/JP2008/053092

§ 371 Date: Aug. 18, 2009

(30) Foreign Application Priority Data
Feb. 23, 2007 (JP) 2007-043432

(51) Int. Cl. G02B 1/11

(52) U.S. Cl. 359/601

(57) ABSTRACT

Provided is an antireflection structural body including a substrate having a property of transmitting light in a wavelength range to be used and an antireflection layer arranged on the substrate. This structural body exhibits high antireflection performance, and provides a high degree of freedom in selecting a material to be used for the antireflection layer regardless of the refractive index of the substrate. The antireflection layer has a periodic structure of an arrangement of projections. The period of the arrangement of the projections in the antireflection layer is not greater than the shortest wavelength of the above wavelength range. A low refractive index layer having a lower refractive index than that of the substrate is arranged between the substrate and the antireflection layer.

### TECHNICAL FIELD

The present invention relates to an antireflection structural body having a surface with a reduced light reflection, and more specifically, relates to an antireflection structural body having a structure in which projections are arranged at a period of not greater than a wavelength of incident light.

### BACKGROUND ART

In recent years, an antireflection structural body having on its surface a structure (hereinafter also referred to simply as a “periodic structure”) in which fine projections are arranged periodically has been put to practical use. The periodic structure is formed directly on the surface of a substrate constituting the antireflection structural body, or in an antireflection layer (hereinafter also referred to as a “periodic structure layer” because the periodic structure is formed therein) arranged on the surface of the substrate. A common example of such a periodic structure is a structure in which projections having a shape of a circular cone or pyramid are arranged at a period of not greater than a wavelength of light that is incident upon the structural body. The periodic structure is called a “moth-eye structure” on account of its appearance.

In the periodic structure layer, the percentage of area occupied by the material that forms the periodic structure (i.e., the material that forms the projections) changes continuously in the thickness direction of the periodic structure layer. Specifically, toward an incident medium (i.e., air), the percentage of area occupied by the material decreases and that occupied by the incident medium increases. In this case, if the refractive index of the material that forms the periodic structure is almost equal to the refractive index of the substrate, the apparent refractive index changes continuously between the incident medium and the substrate, and thereby, light reflection on the surface of the structural body is reduced. The apparent refractive index also changes continuously when the periodic structure is formed directly on the surface of the substrate. In this case, since the periodic structure is formed on a part of the substrate, the refractive index of the material that forms the periodic structure is equal to that of the substrate.

Various types of periodic structures have been proposed. For example, there have been proposed various shapes of projections including not only a cone such as the above-mentioned circular cone or pyramid but also a frustum and a bell shape. Examples of the arrangement of projections include a two-dimensional grid pattern in which projections are arranged in a matrix (array) viewed from a direction perpendicular to the surface of a structural body, and a one-dimensional grid pattern (line pattern) in which projections extending in a predetermined direction (for example, projections having a triangular cross section taken along a plane perpendicular to its extending direction) are arranged in parallel to each other.

Specific background art is shown below. JP 2003-90902 A discloses an antireflection molded film for imparting an antireflection function to window materials for various articles such as a liquid crystal display of a cellular phone. Fine projections for preventing reflection are arranged periodically on the surface of the film, and the arrangement period of the projections is not greater than the shortest wavelength of visible light. The projections have a shape in which a cross section decreases continuously from the base portion to the tip portion.

JP 2005-157119 A discloses an optical element having on its surface a structure in which fine projections are arranged at a period smaller than a visible light wavelength. In this optical element, the periodic structure thereof suppresses the reflection of light on the surface of the element. JP 2005-157119 A describes that a difference between the refractive index of the substrate (optical element) and that of the projections is desirably 0.1 or less (further desirably 0.05 or less), and that as the difference increases after it exceeds 0.1, the reflection at the interface between them increases excessively, which impairs the antireflection effect of the optical element (see paragraph [0025]).

Not only by making the refractive indices of the substrate and the projections approximately equal to each other, but also by making the height of the projections greater with respect to the arrangement period thereof, the above-mentioned change in the refractive index becomes more gradual, which achieves high antireflection performance. It is, however, difficult to form and arrange tall projections uniformly and precisely. Furthermore, as the height of the projections increases, the sharpness of the tips of the projections increases. Accordingly, the mechanical strength of the projections decreases, and thereby the projections (or the periodic structure layer) are susceptible to cracking and abrasion. When the projections are cracked or abraded, the sharpness of the projection's shape is lost, which decreases the antireflection performance of the structural body. Thus, it is difficult as a practical matter to obtain antireflection performance as designed only by controlling the height of the projections.

JP 2005-173457 A discloses an optical element having on its surface fine projections arranged at a period of not greater than a wavelength of light to be used. The projections have a shape that satisfies a given equation for the height, and thereby, in spite of their small height, the resulting optical element exhibits excellent antireflection performance. The projections of this element satisfy the above equation on the precondition that they have a shape of a frustum or a bell shape. However, this element does not necessarily exhibit sufficient antireflection performance, compared with an element provided with projections having a sharp-pointed tip like a cone.

As described above, in the conventional antireflection structural body, in order to suppress reflection of light, it is necessary to make the refractive index of the substrate and that of the periodic structure layer as equal as possible to allow the apparent refractive index to change continuously between the incident medium and the substrate. In addition, because of manufacturing constraints (for example, materials to be used for forming a periodic structure layer are required to have good workability to form a periodic arrangement of fine projections), only limited types of materials are available to form the periodic structure layer. It is a fact that there are very few materials to be used for forming the periodic structure layer, particularly on a substrate made of a highly refractive material with a refractive index of more than 2, to be used for optical elements.

### DISCLOSURE OF THE INVENTION

It is an object of the present invention to provide an antireflection structural body that exhibits high antireflection performance and provides a high degree of freedom in selecting a material to be used for a periodic structure layer regardless of a refractive index of a substrate.

The antireflection structural body of the present invention includes: a substrate having a property of transmitting light in a wavelength range to be used; and an antireflection layer (periodic structure layer) arranged on the substrate. The antireflection layer has a periodic structure of an arrangement of projections, and the arrangement period of the projections in the antireflection layer is not greater than a shortest wavelength in the wavelength range. This antireflection structural body further includes, between the substrate and the antireflection layer, a low refractive index layer having a lower refractive index than a refractive index of the substrate.

In the antireflection structural body of the present invention, by virtue of the presence of the low refractive index layer, high antireflection performance can be achieved even if the projections of the periodic structure layer has a shape without a sharp-pointed tip, such as a frustum.

Furthermore, due to the presence of the low refractive index layer, the degree of freedom of the refractive index for the periodic structure layer with respect to the refractive index of the substrate can be increased. In other words, in the structural body of the present invention, the degree of freedom in selecting a material for the periodic structure layer can be improved. This effect is particularly noticeable in the case where the substrate has a high refractive index (for example, 1.5 or more), such as a case where the structural body of the present invention is used for an optical element.

### BRIEF DESCRIPTION OF THE DRAWINGS

FIG. 1 is a cross-sectional view illustrating schematically a cross section in the thickness direction of one example of an antireflection structural body of the present invention.

FIG. 2 illustrates an average reflection coefficient of an antireflection structural body of the present invention used in Calculation Example 1 that changes in accordance with a change in the refractive index ratio (n₂/n₁:n₁ is a refractive index of a substrate and n₂ is a refractive index of a low refractive index layer) of the structural body.

FIG. 3 illustrates a relationship between a wavelength λ of incident light and a reflection coefficient at an incident angle of 0 degree, for the antireflection structural body of the present invention used in Calculation Example 1 and a conventional antireflection structural body.

FIG. 4 illustrates a relationship between a wavelength λ of incident light and a reflection coefficient at an incident angle of 30 degrees, for the antireflection structural body of the present invention used in Calculation Example 1 and the conventional antireflection structural body.

FIG. 5 illustrates a relationship between a wavelength λ of incident light and a reflection coefficient at an incident angle of 40 degrees, for the antireflection structural body of the present invention used in Calculation Example 1 and the conventional antireflection structural body.

FIG. 6 illustrates a relationship between a wavelength λ of incident light and a reflection coefficient at an incident angle of 50 degrees, for the antireflection structural body of the present invention used in Calculation Example 1 and the conventional antireflection structural body.

FIG. 7 illustrates a relationship between an incident angle θ of incident light and an average reflection coefficient that changes in accordance with a change in a ratio (H/P) between a height of projections and an arrangement period thereof, for the antireflection structural body of the present invention used in Calculation Example 1 and the conventional antireflection structural body.

FIG. 8 illustrates an average reflection coefficient of the antireflection structural body of the present invention used in Calculation Example 1 that changes in accordance with a change in a ratio (B/P) between a lower base of projections and an arrangement period hereof.

FIG. 9 illustrates an average reflection coefficient of the antireflection structural body of the present invention used in Calculation Example 1 that changes in accordance with a change in a ratio (W/P) between an upper base of projections and an arrangement period thereof.

FIG. 10 illustrates an average reflection coefficient of the antireflection structural body of the present invention used in Calculation Example 1 that changes in accordance with a change in an optical thickness (optical film thickness) of a low refractive index layer.

FIG. 11 illustrates an average reflection coefficient of an antireflection structural body of the present invention used in Calculation Example 2 that changes in accordance with a change in a refractive index ratio (n₂/n₁).

FIG. 12 illustrates an average reflection coefficient of the antireflection structural body of the present invention used in Calculation Example 2 that changes in accordance with a change in an optical film thickness of a low refractive index layer.

FIG. 13 illustrates an average reflection coefficient of an antireflection structural body of the present invention used in Calculation Example 3 that changes in accordance with a change in a refractive index ratio (n₂/n₁).

FIG. 14 illustrates an average reflection coefficient of the antireflection structural body of the present invention used in Calculation Example 3 that changes in accordance with a change in an optical film thickness of a low refractive index layer.

FIG. 15 illustrates an average reflection coefficient of an antireflection structural body of the present invention used in Calculation Example 4 that changes in accordance with a change in a refractive index ratio (n₃/n₁:n₃ is a refractive index of a periodic structure layer).

### BEST MODE FOR CARRYING OUT THE INVENTION

Hereafter, the antireflection structural body of the present invention is described.

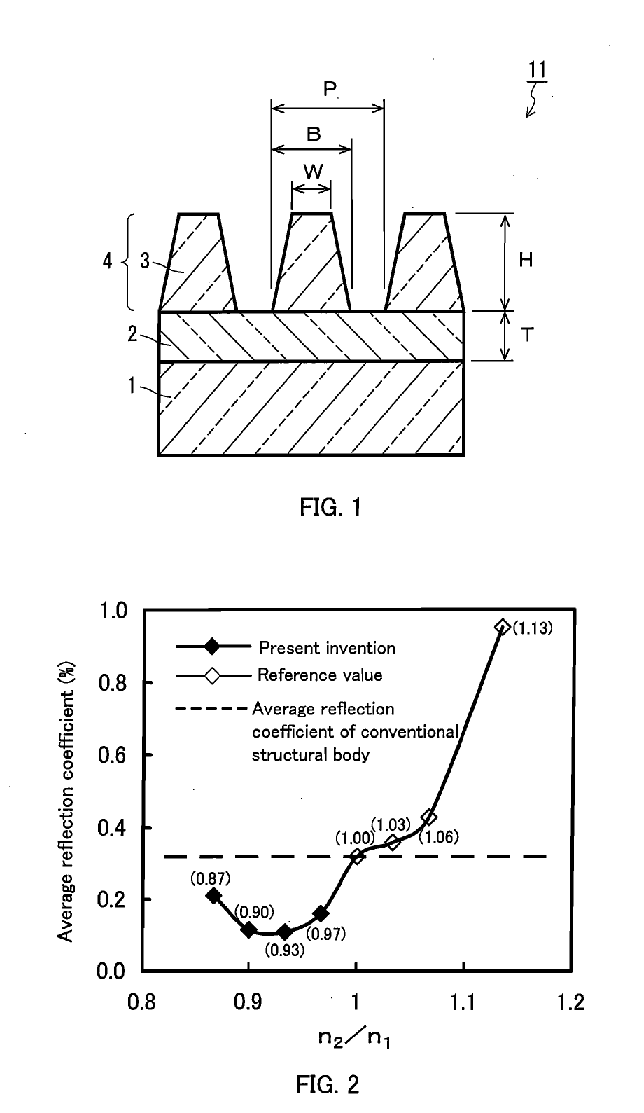

FIG. 1 shows one example of the antireflection structural body of the present invention. An antireflection structural body 11 shown in FIG. 1 has a structure in which a low refractive index layer 2 having a lower refractive index than that of a substrate 1 and an antireflection layer (periodic structure layer) 4 having a periodic structure of an arrangement of projections 3 are stacked in this order on the substrate 1. The substrate 1 has a property of transmitting light in a wavelength range to be used. The light in the wavelength range to be used is, for example, visible light (at least 400 nm to not more than 750 nm), ultraviolet light (at least 320 nm to less than 400 nm), or near-infrared light (more than 750 nm to not more than 2500 nm), and typically it is visible light. The definition of these wavelength ranges is a standard definition, and light in a part of any of the above wavelength ranges or light in two or more of these wavelength ranges may be used depending on the use of the antireflection structural body of the present invention.

The low refractive index layer 2 is a layer made of a material with a lower refractive index than that of the substrate 1 and having a predetermined physical thickness (physical film thickness) T. Preferably, the surface of the low refractive index layer 2 is flat, unlike the periodic structure layer 4 in which the projections 3 are arranged. The low refractive index layer 2 has a property of transmitting light in the above wavelength range (typically visible light) that is incident upon the structural body 11. Here, the phrase “having a property of transmitting light” means having a property of transmitting at least a part of incident light.

The periodic structure layer 4 has a periodic structure in which the projections 3 are arranged periodically. The arrangement period P of the projections 3 in the periodic structure layer 4 is not greater than the shortest wavelength in the wavelength range. In other words, the arrangement period P of the projections 3 for suppressing the reflection of light in a wavelength range is not greater than the shortest wavelength in the wavelength range. For example, when the arrangement period P is not greater than the shortest wavelength of visible light, the reflection of light in the entire range of visible light is suppressed in the structural body 11. The periodic structure layer 4 (projections 3) has a property of transmitting light (typically visible light) in the wavelength range that is incident upon the structural body 11. The lower limit of the arrangement period P of the projections 3 cannot be determined definitely because it varies depending on the material to be used for the periodic structure layer 4 and the method of forming the periodic structure layer 4. For example, it is about 50 m. The possible range of the height H of the projections 3 also cannot be determined definitely because it varies depending on the material to be used for the periodic structure layer 4 and the method of forming the periodic structure layer 4. For example, it is about 0.5 to 5 when expressed as a ratio (H/P) between the height H of the projections and the arrangement period P thereof.

The shape of the projections 3 is not particularly limited as long as it is tapered as the distance from the low refractive index film 2 increases. In other words, when considering a cross section of the periodic structure layer 4 taken parallel to the surface of the low refractive index film 2, the projections 3 have a shape in which the percentage of area occupied by the projections 3 on the cross section decreases continuously as the distance from the low refractive index film 2 increases. The shape of the projections 3 is, for example, a cone such as a circular cone or pyramid, a frustum such as a conical frustum or pyramidal frustum, a bell shape, or a dome shape.

The shape of the projections 3 in the structural body 11 shown in FIG. 1 is a conical frustum, and the projections 3 have a cross section of a trapezoid in the thickness direction of the periodic structure layer 4. The bottom surface (lower base of the trapezoid) of the projections 3 is in contact with the low refractive index film 2, and the top surface (upper base of the trapezoid) and side surface thereof are exposed to outside.

The shape of the projections in the antireflection structural body of the present invention need not strictly be one of the shapes exemplified above. For example, it may be a partially rounded shape, such as a cone with a rounded tip or rounded ridge.

The arrangement of the projections 3 is not limited as long as a certain period is observed as seen from a direction perpendicular to the surface of the substrate 1 on which the periodic structure layer 4 is arranged. For example, the arrangement of the projections 3 may be a two-dimensional grid pattern in which the projections 3 having a shape of a cone or a frustum, a bell shape, or a dome shape are arranged in a matrix (array) as seen from that direction. The arrangement of the projections 3 may be a one-dimensional grid pattern (line pattern) in which two or more projections 3 extending in a predetermined direction are arranged in parallel to each other. In this case, the shape of the cross section of the projections taken along a plane perpendicular to its extending direction is not particularly limited as long as the above conditions of the projection shape are satisfied. For example, it is a triangle, a trapezoid, or a part of a circle.

In the case where the projections 3 are arranged in the one-dimensional grid pattern, since it is generally a simpler pattern than the two-dimensional grid pattern, the periodic structure layer 4 can be formed more easily, which improves the ease of manufacturing the structural body 11. In this case, the antireflection performance of the structural body 11 changes according to the relationship between the periodic direction of the projections 3 and the amplitude direction of the light that is incident upon the structural body 11.

The periodic direction of the projections 3 in the two-dimensional grid pattern is a direction connecting the center points of two nearest neighbor projections 3 (center points of the images of the projections 3 projected on the plane parallel to the surface of the substrate 1 on which the periodic structure layer 4 is arranged).

In the antireflection structural body 11 of the present invention, the apparent refractive index in the periodic structure layer 4 changes relatively gradually in the thickness direction of the layer as the height H of the projections 3 increases, as in the case of conventional structural bodies. Thus, the antireflection performance increases. Furthermore, as the length B of the bottom surface of the projections 3 in the periodic direction approaches the arrangement period P, the amount of the light that is incident directly upon the low refractive index layer 2 without being incident upon the projections 3 can be reduced more (in another respect, a steep change in the apparent refractive index at the interface between the periodic structure layer 4 and the low refractive index layer 2 can be reduced more). Thus, the antireflection performance of the structural body 11 is enhanced. More preferably, the length B of the bottom surface is equal to the arrangement period P. As shown in the calculation examples to be described later, the antireflection structural body 11 of the present invention exhibits higher antireflection performance when the projections 3 have a shape with a flattened tip, such as a frustum, than when they have a sharp-pointed tip.

The refractive index of the material that forms the periodic structure layer 4 (material that forms the projections 3) is not particularly limited, as shown in Calculation Example 4 to be described later.

Hereinafter, the structural body of the present invention will be described in further detail using specific calculation examples.

### Calculation Example 1

Assuming the case where the antireflection structural body of the present invention is constructed using a substrate with a refractive index of 1.5, the reflection coefficient of the antireflection structural body was calculated. In Calculation Example 1, the calculations were performed assuming the antireflection structural body having the structure shown in FIG. 1. In the structural body used for the calculations, the low refractive index layer and the periodic structure layer (projections) were made of the same material. The magnitude relationship among the refractive index n₁ of the substrate, the refractive index n₂ of the low refractive index layer, and the refractive index n₃ of the periodic structure layer (projections) is “n₂=n₃<n₁”. In the case where the low refractive index layer and the periodic structure layer are made of the same material as just mentioned above, both layers can be formed at a time.

The arrangement period P of the projections in the periodic structure layer was 180 nm, the height H thereof was 270 nm, the ratio (HIP) between the height H and the period P was 1.5, and the length B of the bottom surface in the periodic direction was 180 nm (i.e., B/P=1). The shape of the projections is a conical frustum, and has a cross section of a trapezoid in the thickness direction of the periodic structure layer (the length B of the bottom surface of the projections can be regarded as equivalent to the lower base of the trapezoid).

The calculations were performed using incident light having a wavelength λ in a range of 420 to 780 nm, while changing the incident angle in a range of 0 to 50 degrees. As for the incident light, the calculations were performed separately for TE-polarized light (whose electric field components are perpendicular to the plane of incidence) and TM-polarized light (whose electric field components are parallel to the plane of incidence). The center wavelength λ₀ of the incident light is 600 nm, and the arrangement period P of the projections is in a relation of P=0.3×λ₀ with respect to the center wavelength λ₀ of the incident light. In other calculation examples, the calculations were performed in the same manner.

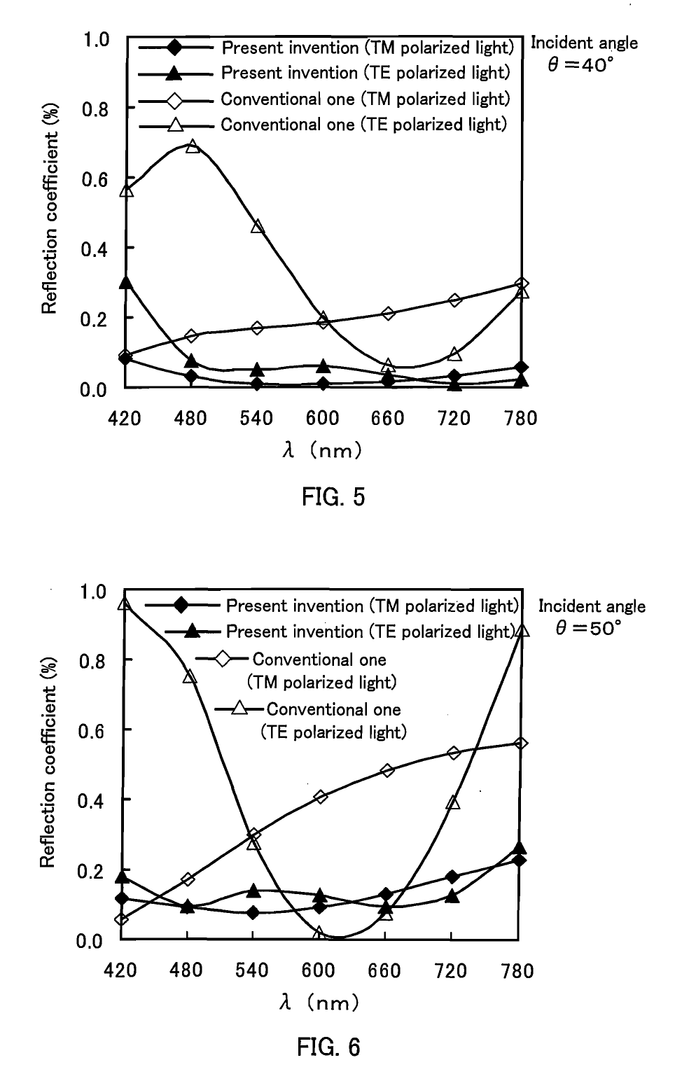

The results of the calculations are described below with reference to FIG. 2 to FIG. 10.

FIG. 2 shows the average reflection coefficient of the structural body that changes in accordance with a change in the refractive index ratio (n₂/n₁) between the substrate and the low refractive index layer. In the calculations for obtaining the results shown in FIG. 2, the upper base W of the projections and the physical film thickness T of the low refractive index layer were optimized in a range of 50 to 70 nm and in a range of 70 to 90 nm, respectively, so as to minimize the average reflection coefficient of the assumed structural body.

The average reflection coefficient means an average value of the reflection coefficients of the structural body obtained when changing the wavelength λ of incident light from 420 nm to 780 nm and the incident angle θ from 0 to 50 degrees. Numerical values in parentheses in FIG. 2 are the values of the ratio (n₂/n₁) at respective points.

FIG. 2 also indicates, as reference values, the results of the calculations obtained in the case of n₁≦n₂ (in this case, a film having a refractive index equal to that of the substrate or a film having a refractive index higher than that of the substrate is arranged on the substrate). FIG. 2 further indicates the results of the calculations performed for a conventional antireflection structural body (having an average reflection coefficient of 0.32%). This conventional structural body was obtained by removing the low refractive index layer 2 from the structural body 11 shown in FIG. 1 and forming the periodic structure layer 4 (projections 3) directly on the surface of the substrate 1 (the same conventional structural body also was used in following calculation examples). In the assumed conventional structural body, the periodic structure layer and the substrate had the same refractive index (n₁=n₃=1.5).

As shown in FIG. 2, when the refractive index ratio (n₂/n₁) between the low refractive index layer and the substrate was 0.8≦n₂/n₁<1, the average reflection coefficient was lower than that of the conventional structural body. On the other hand, when the refractive index ratio (n₂/n₁) was 1 or more as indicated as the reference values, the average reflection coefficient was higher than that of the assumed conventional structural body. Thus, the superiority of the structural body of the present invention was lost.

Since the refractive index n₁ of the substrate is 1.5 in Calculation Example 1, the refractive index of the material that forms the low refractive index layer and the periodic structure layer can be selected from a range of 1.2≦n₂(n₃)<1.5. As described in JP 2005-157119 A, it is desired that in the conventional structural body without a low refractive index layer, the difference between the refractive index of the substrate and that of the periodic structure layer be as small as possible, at most 0.1. In contrast, in the structural body of the present invention, it is found that the degree of freedom in selecting a material for forming the periodic structure layer can be improved significantly.

As shown in FIG. 2, when the refractive index ratio (n₂/n₁) between the low refractive index layer and the substrate was 0.8≦n₂/n₁<1, the antireflection performance is improved compared with the conventional structural body. When the ratio (n₂/n₁) is 0.87≦n₂/n₁≦0.97, the antireflection performance is improved significantly compared with the conventional structural body. These ranges of the ratio n₂/n₁ values are particularly preferable when the refractive index n₁ of the substrate is 1.3 to 1.8, and further preferable when the refractive index n₁ is at least 1.3 to less than 1.75. In the calculations for obtaining the results shown in FIG. 2, W and T were optimized in a range of 50 to 70 nm and in a range of 70 to 90 nm, respectively, in the cases of 0.8≦n₂/n₁<1 and 0.87≦n₂/n₁≦0.97.

When considering a method of actually forming the periodic structure layer and ease of manufacturing the antireflection structural body, the refractive index ratio (n₂/n₁) between the low refractive index layer and the substrate is preferably 0.93 or less, at which the structural body assumed in Calculation Example 1 exhibits the maximum antireflection performance. Specifically, the ratio (n₂/n₁) is preferably 0.8≦n₂/n₁≦0.93, and more preferably 0.87≦n₂/n₁≦0.93. The reasons for this are as follows. These ranges of n₂/n₁ values are particularly preferable when the refractive index n₁ of the substrate is 1.3 to 1.8, and further preferable when n₁ is at least 1.3 to less than 1.75. In the calculations for obtaining the results shown in FIG. 2, W and T were optimized in a range of 50 to 70 nm and in a range of 70 to 90 nm, respectively, in the cases of 0.8≦n₂/n₁≦0.93 and 0.87≦n₂/n₁≦0.93.

The method of forming the periodic structure layer is not particularly limited, and it is easy and convenient to use a method of forming the projections by a press transfer method to be described later and obtaining the periodic structure layer. When the press transfer method is used, it is desired that the refractive index of a material for forming the periodic structure layer be not too high (for example, less than 1.5). This is because highly refractive materials have drawbacks at present, such as low workability and difficulty in press transfer, poor durability as a periodic structure layer, and high cost. Furthermore, if the periodic structure layer and the low refractive index layer are made of the same material, both layers can be formed at one time and the ease of manufacturing the antireflection structural body can be improved. From these viewpoints, it is desirable that the low refractive index layer have a lower refractive index. On the other hand, in the case where the antireflection structural body is an optical element such as a lens and a prism, highly refractive materials are used in many cases for the purpose of improving the optical performance of the antireflection structural body. Accordingly, when considering a method of forming the periodic structure layer and ease of manufacturing the antireflection structural body, it is preferable that the refractive index difference between the substrate and the low refractive index layer be as great as possible, that is, the ratio (n₂/n₁) be as small as possible. For the reasons mentioned above, it is preferable that the ratio (n₂/n₁) be in the above-mentioned range of values up to an optimum value of 0.93 as an upper limit.

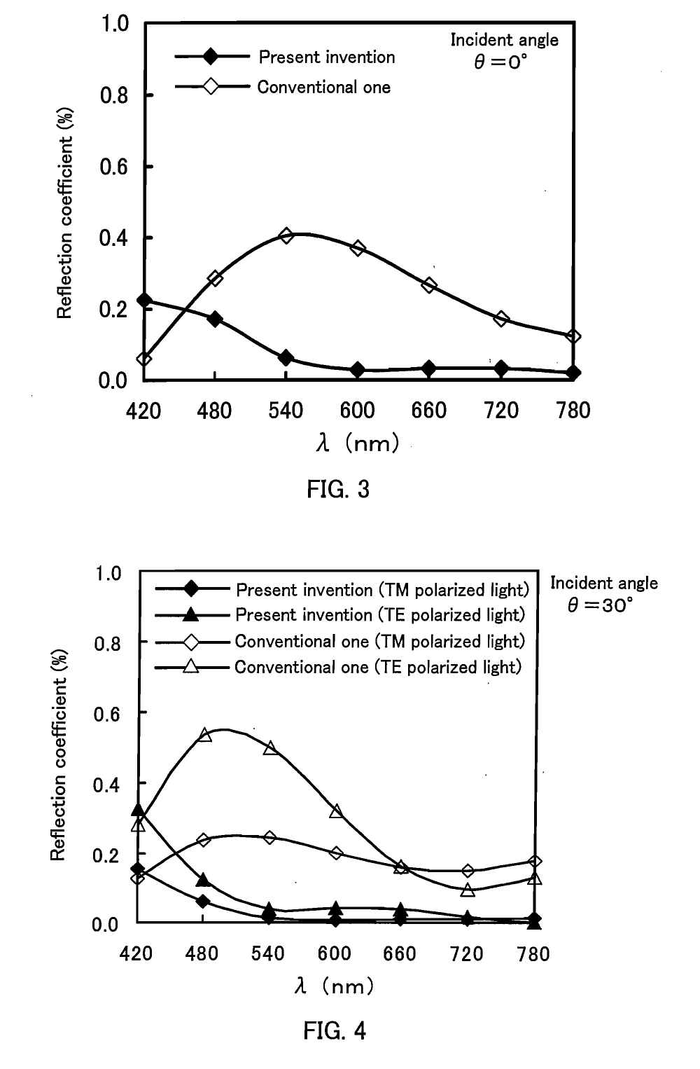

Next, FIGS. 3 to 6 each show a relationship between the wavelength of incident light and the reflection coefficient of the structural body of the present invention assumed as above, with the refractive index ratio (n₂/n₁) between the substrate and the low refractive index layer fixed at 0.93, at which the structural body exhibits the maximum antireflection performance. FIGS. 3 to 6 show the results of the calculations performed when the incident angles θ were set to 0, 30, 40, and 50 degrees, respectively. FIGS. 4 to 6 show the calculation results of reflection coefficients for TM-polarized light and TE-polarized light separately. When the incident angle θ is 0 degree (FIG. 3), the reflection coefficient of TM-polarized light is equal to that of TE-polarized light. In the calculations for obtaining the results shown in FIGS. 3 to 6, the upper base W of the projections was 61 nm (W/P=0.34), and the physical film thickness T of the low refractive index layer was 88 nm (T/λ₀=0.15).

FIGS. 3 to 6 also indicate the reflection coefficients of the conventional antireflection structural body that were calculated in the same manner.

As shown in FIGS. 3 to 6, the reflection coefficient of the structural body of the present invention at λ=420 to 780 nm decreased considerably compared with that of the conventional structural body, although the magnitude relationship of the reflection coefficients is reversed partially in some wavelength ranges. Furthermore, the structural body of the present invention has a low wavelength dependence of the reflection coefficient compared with the conventional structural body. Accordingly, it was found that the structural body of the present invention can achieve a low reflection coefficient regardless of the wavelength of incident light.

Next, the shape of the projections of the periodic structure layer was changed. In the structural body of the present invention, it is considered that the shape of the projections of the periodic structure layer has a significant effect on the antireflection performance.

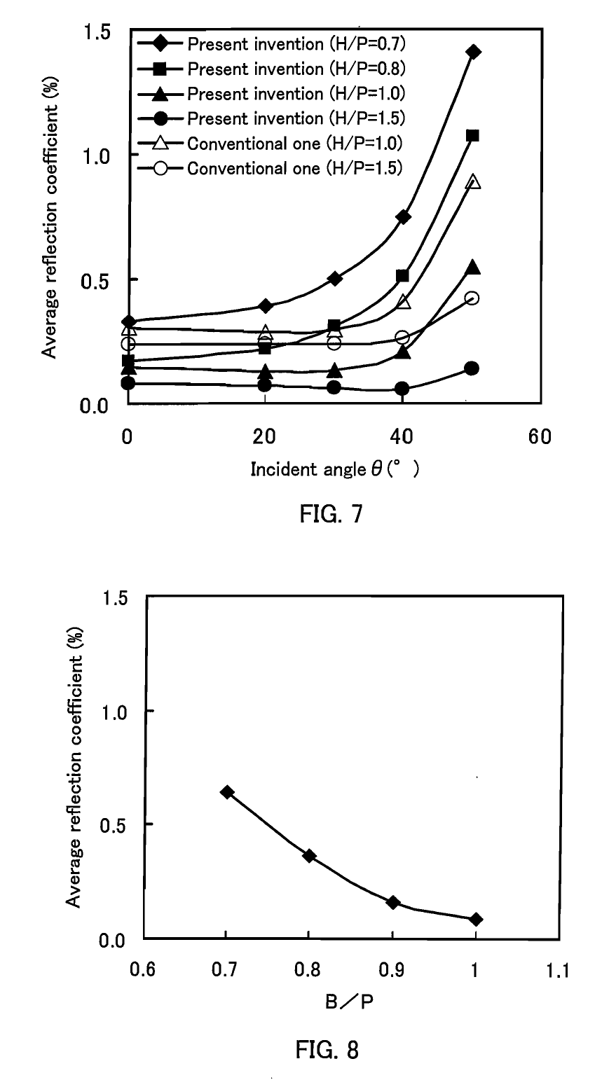

FIG. 7 shows, for the antireflection structural body of the present invention assumed as above, a relationship between the average reflection coefficient and the incident angle θ that changes in accordance with a change in the ratio (H/P) between the height H of the projections and the arrangement period P thereof. In the calculations for obtaining the results shown in FIG. 7, the refractive index ratio (n₂/n₁) between the substrate and the low refractive index layer was fixed at 0.93, and the upper base W of the projections and the physical film thickness T of the low refractive index layer were optimized in the above-mentioned ranges, respectively, so as to minimize the average reflection coefficient of the assumed structural body.

As shown in FIG. 7, the antireflection performance of the structural body of the present invention was enhanced as the ratio (H/P) increased. Furthermore, in the structural body of the present invention, the average reflection coefficient was constant not only at a specific incident angle θ but also in a wide range of incident angles θ. Particularly, the average reflection coefficient was almost constant in the entire range of incident angles θ of 0 to 50 degrees when the ratio (H/P) was 1.5. In addition to an antireflection structural body having a periodic structure layer, conventionally known is an antireflection structural body in which a thin film is arranged on the surface of the substrate and the reflection coefficient is reduced by interference of light in the thin film. In such an antireflection structural body utilizing this interference of light, however, the reflection coefficient has an extremely high dependence on the incident angle and incident wavelength in its principle. Therefore, sufficient antireflection performance cannot be obtained for light that is incident at an angle other than a designed incident angle and light in a wavelength range other than a designed range. In contrast, the structural body of the present invention can exhibit high antireflection performance for incident light in a wide range of wavelengths and at a wide range of incident angles by controlling the shape of the projections, as shown in FIGS. 3 to 6 and FIG. 7.

To reduce the average reflection coefficient of the structural body to about 1% or less in the entire range of incident angles θ of 0 to 50 degrees, the ratio (H/P) between the height H of the projections and the arrangement period P thereof is preferably 0.8≦H/P.

The same relationship between the average reflection coefficient of the structural body and the ratio (H/P) also tends to be established in the case where the refractive index ratio (n₂/n₁) is in each of the above-mentioned ranges of 0.8≦n₂/n₁<1, 0.87≦n₂/n₁≦0.97, 0.8≦n₂/n₁≦0.93, and 0.87≦n₂/n₁≦0.93. Preferably, the ratio (H/P) is 0.8 or more. The same applies to the preferable ranges of refractive index ratio (n₂/n₁) shown in Calculation Examples 2 and 3.

As shown in FIG. 7, the structural body of the present invention exhibits higher antireflection performance than that of the conventional structural body, when compared at the same ratio (H/P). The antireflection performance of the structural body of the present invention with a ratio (H/P) of 0.8 is almost the same level as that of the conventional structural body with a ratio (H/P) of 1. This shows that, in the structural body of the present invention, the height H of the projections can be reduced if the target antireflection performance is the same as that of the conventional one. Therefore, the periodic structure layer of the structural body of the present invention can be formed more easily than that of the conventional structural body. In addition, because of the high mechanical strength of the periodic structure layer, the structural body of the present invention can have excellent resistance to cracking and abrasion.

FIG. 8 shows the average reflection coefficient of the structural body of the present invention assumed as above that changes in accordance with a change in the ratio (B/P) between the length B of the bottom surface (lower base) of the projections and the arrangement period P thereof. In the calculations for obtaining the results shown in FIG. 8, the refractive index ratio (n₂/n₁) between the substrate and the low refractive index layer was fixed at 0.93, the upper base W of the projections was set to 60 nm (i.e., W/P of 0.33), and the physical film thickness T of the low refractive index layer was optimized in a range of 70 to 100 nm so as to minimize the average reflection coefficient of the assumed structural body.

As shown in FIG. 8, the average reflection coefficient of the structural body decreased as the ratio (B/P) increased, and it reached a minimum when the ratio (B/P) was 1 (i.e., B=P). This is because the area of the low refractive index layer that is not covered by the projections decreases as the length B of the bottom surface of the projections approaches the arrangement period P thereof, that is, a steep change in the apparent refractive index at the interface between the periodic structure layer and the low refractive index layer can be reduced.

As shown in FIG. 8, the average reflection coefficient of the structural body can be reduced to 1% or less when the ratio (B/P) between the length B of the bottom surface of the projections and the arrangement period P thereof is 0.7≦B/P≦1.

The same relationship between the average reflection coefficient of the structural body and the ratio (B/P) also tends to be established in the case where the refractive index ratio (n₂/n₁) is in each of the above-mentioned ranges of 0.8≦n₂/n₁21 1, 0.87≦n₂/n₁≦0.97, 0.8≦n₂/n₁≦0.93, and 0.87≦n₂/n₁≦0.93. Preferably, the ratio (B/P) is 0.7≦B/P≦1. The same applies to the preferable ranges of refractive index ratio (n₂/n₁) shown in Calculation Examples 2 and 3.

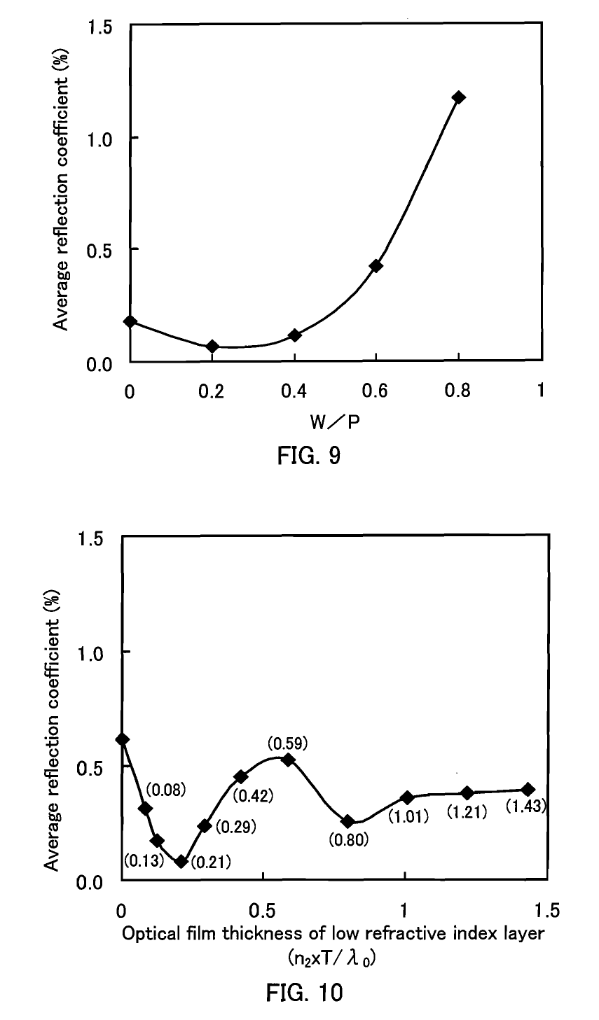

FIG. 9 shows the average reflection coefficient of the structural body of the present invention assumed as above that changes in accordance with a change in the ratio (W/P) between the upper base W of the projections and the arrangement period P thereof. In the calculations for obtaining the results shown in FIG. 9, the refractive index ratio (n₂/n₁) between the substrate and the low refractive index layer was fixed at 0.93, and the physical film thickness T of the low refractive index layer was optimized in a range of 70 to 90 nm so as to minimize the average reflection coefficient of the assumed structural body.

As shown in FIG. 9, the average reflection coefficient of the structural body reached a minimum when the ratio (W/P) was 0.2 to 0.3. This means that higher antireflection performance can be obtained when the tip of each projection is not sharp-pointed but flattened in shape in the structural body of the present invention. To reduce the average reflection coefficient of the structural body to 1% or less, the ratio (W/P) between the upper base W of the projections and the arrangement period P thereof may be W/P≦0.7.

The same relationship between the average reflection coefficient of the structural body and the ratio (W/P) also tends to be established in the case where the refractive index ratio (n₂/n₁) is in each of the above-mentioned ranges of 0.8≦n₂/n₁<1, 0.87≦n₂/n₁≦0.97, 0.8≦n₂/n₁≦0.93, and 0.87≦n₂/n₁≦0.93. Preferably, the ratio (W/P) is 0.7 or less. The same applies to the preferable ranges of refractive index ratio (n₂/n₁) shown in Calculation Examples 2 and 3.

Next, the physical film thickness T of the low refractive index layer was changed. In the structural body of the present invention, it is considered that the physical film thickness T of the low refractive index layer as well as the shape of the projections have a significant effect on the antireflection performance.

FIG. 10 shows the average reflection coefficient of the structural body of the present invention assumed as above that changes in accordance with a change in the physical film thickness T of the low refractive index film. In the calculations for obtaining the results shown in FIG. 10, the refractive index ratio (n₂/n₁) between the substrate and the low refractive index layer was fixed at 0.93, and the upper base W of the projections was optimized in a range of 60 to 100 nm so as to minimize the average reflection coefficient of the assumed structural body. In FIG. 10, not the physical film thickness T of the low refractive index layer but the optical thickness (optical film thickness: n₂×T/λ₀) normalized by the center wavelength λ₀ (=600 nm) of incident light is plotted on the horizontal axis. Numerical values in parentheses in FIG. 10 are the optical film thickness values of the low refractive index layer at respective points.

As shown in FIG. 10, the average reflection coefficient of the structural body fluctuated in accordance with a change in the optical film thickness of the low refractive index layer. From the course of the fluctuation of the average reflection coefficient shown in FIG. 10, it is considered that in the structural body of the present invention, a reflected wave generated on the periodic structure layer (most of the light that is incident upon the periodic structure layer passes through the periodic structure layer but only a small amount of light is reflected on that layer) interfered with a reflected wave generated from a part of the light that passed through the periodic structure layer and was reflected at the interface between the low refractive index layer and the substrate. These reflected waves canceled each other, and thereby high antireflection performance was achieved.

The results shown in FIG. 10 show that when the low refractive index layer has an optical thickness of 0.1λ₀ to 0.3λ₀, particularly high antireflection performance can be achieved in spite of its very small thickness in suppressing reflection of visible light. In the assumed structural body, 0.1λ₀ to 0.3λ₀ in the optical thickness of the low refractive index layer is equivalent to 40 to 130 nm in the physical film thickness T of that layer.

The same relationship between the average reflection coefficient of the structural body and the optical film thickness of the low refractive index layer also tends to be established in the case where the refractive index ratio (n₂/n₁) is in each of the above-mentioned ranges of 0.8≦n₂/n₁<1, 0.87≦n₂/n₁≦0.97, 0.8≦n₂/n₁≦0.93, and 0.87≦n₂/n₁≦0.93. Preferably, the optical film thickness of the low refractive index layer is 0.1λ₀ to 0.3λ₀.

### Calculation Example 2

Assuming the case where the antireflection structural body of the present invention is constructed using a substrate with a refractive index of 1.8 (n₁=1.8), the reflection coefficient of the antireflection structural body was calculated. In Calculation Example 2, the calculations were performed assuming the antireflection structural body having the structure shown in FIG. 1, as in the case with Calculation Example 1. In the structural body used for the calculations, the low refractive index layer and the periodic structure layer (projections) were made of the same material. The shape and arrangement of the projections were the same as those used in Calculation Example 1. A substrate having a refractive index of 1.8 is used suitably as a substrate for optical elements such as a camera lens.

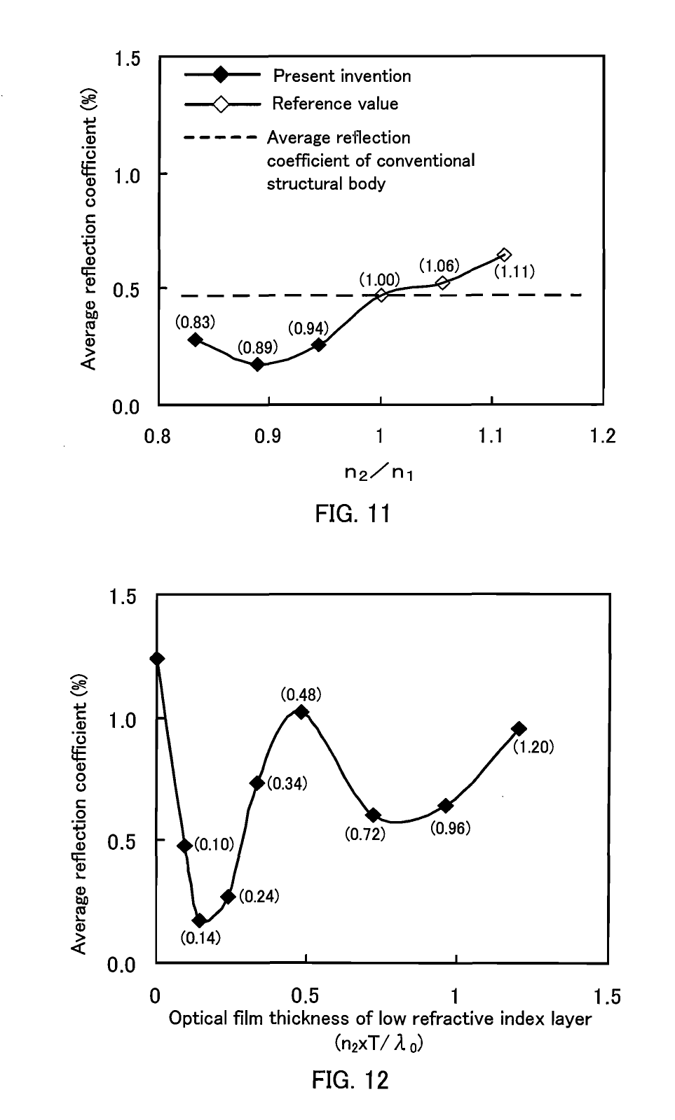

The results of the calculations are described below with reference to FIGS. 11 and 12.

FIG. 11 shows the average reflection coefficient of the structural body that changes in accordance with a change in the refractive index ratio (n₂/n₁) between the substrate and the low refractive index layer. In the calculations for obtaining the results shown in FIG. 11, the upper base W of the projections and the physical film thickness T of the low refractive index layer were optimized in a range of 40 to 70 nm and in a range of 50 to 70 nm, respectively, so as to minimize the average reflection coefficient of the assumed structural body.

FIG. 11 also indicates, as reference values, the results of the calculations obtained in the case of n₁≦n₂. FIG. 11 further indicates the results of the calculations performed for a conventional antireflection structural body (having an average reflection coefficient of 0.47%). In the assumed conventional structural body, the periodic structure layer and the substrate had the same refractive index (n₁=n₃=1.8), and the shape and arrangement of the projections were the same as those of the antireflection structural body of the present invention assumed as above. Numerical values in parentheses in FIG. 11 are the values of the ratio (n₂/n₁) at respective points.

As shown in FIG. 11, when the refractive index ratio (n₂/n₁) between the low refractive index layer and the substrate was 0.8≦n₂/n₁<1, the average reflection coefficient was lower than that of the conventional structural body. On the other hand, when the refractive index ratio (n₂/n₁) was 1 or more as indicated as the reference values, the average reflection coefficient was higher than that of the assumed conventional structural body.

Since the refractive index n₁ of the substrate is 1.8 in Calculation Example 2, the refractive index of the material that forms the low refractive index layer and the periodic structure layer can be selected from a range of 1.44≦n₂(n₃)<1.8.

As shown in FIG. 11, when the refractive index ratio (n₂/n₁) between the low refractive index layer and the substrate was 0.8≦n₂/n₁<1, the antireflection performance is improved compared with the conventional structural body. When the ratio (n₂/n₁) is 0.83≦n₂/n₁≦0.94, the antireflection performance is improved significantly compared with the conventional structural body. These ranges of n₂/n₁ values are particularly preferable when the refractive index n₁ of the substrate is 1.7 to 2.2, and further preferable when n₁ is 1.75 to 2.2. In the calculations for obtaining the results shown in FIG. 11, W and T were optimized in a range of 40 to 70 nm and in a range of 50 to 70 nm, respectively, in the cases of 0.8≦n₂/n₁<1 and 0.83≦n₂/n₁≦0.94.

As described in Calculation Example 1, when considering a method of actually forming the periodic structure layer and ease of manufacturing the antireflection structural body, the refractive index ratio (n₂/n₁) between the low refractive index layer and the substrate is preferably 0.89 or less, at which the structural body assumed in Calculation Example 2 exhibits the maximum antireflection performance. Specifically, the ratio (n₂/n₁) is preferably 0.8≦n₂/n₁≦0.89, and more preferably 0.83≦n₂/n₁≦0.89. These ranges of n₂/n₁ values are particularly preferable when the refractive index n₁ of the substrate is 1.7 to 2.2, and further preferable when n₁ is 1.75 to 2.2. In the calculations for obtaining the results shown in FIG. 11, W and T were optimized in a range of 40 to 60 nm and in a range of 50 to 70 nm, respectively, in the case of 0.8≦n₂/n₁≦0.89 and 0.83≦n₂/n₁<0.89.

Next, FIG. 12 shows a relationship between the optical film thickness of the low refractive index layer and the average reflection coefficient of the structural body of the present invention assumed in Calculation Example 2, with the refractive index ratio (n₂/n₁) between the substrate and the low refractive index layer fixed at 0.89, at which the structural body exhibits the maximum antireflection performance. In the calculations for obtaining the results shown in FIG. 12, the upper base W of the projections was optimized in a range of 40 to 90 nm so as to minimize the average reflection coefficient of the assumed structural body. The optical film thickness of the low refractive index layer was normalized by the center wavelength λ₀ (=600 nm) of incident light, as in the case with Calculation Example 1. Numerical values in parentheses in FIG. 12 are the optical film thickness values of the low refractive index layer at respective points.

As shown in FIG. 12, the average reflection coefficient of the structural body fluctuated in accordance with a change in the optical film thickness of the low refractive index layer. From the course of the fluctuation of the average reflection coefficient shown in FIG. 12, it is considered that in the structural body of the present invention, a reflected wave generated on the periodic structure layer interfered with a reflected wave generated at the interface between the low refractive index layer and the substrate. The results shown in FIG. 12 show that when the low refractive index layer has an optical thickness of 0.1λ₀ to 0.3λ₀, particularly high antireflection performance can be achieved in spite of its very small thickness in suppressing reflection of visible light. In the assumed structural body, 0.1λ₀ to 0.3λ₀ in the optical thickness of the low refractive index layer is equivalent to 30 to 120 nm in the physical film thickness T of that layer.

The same relationship between the average reflection coefficient of the structural body and the optical film thickness of the low refractive index layer also tends to be established in the case where the refractive index ratio (n₂/n₁) is in each of the above-mentioned ranges of 0.8≦n₂/n₁<1, 0.83≦n₂/n₁≦0.94, 0.8≦n₂/n₁≦0.89, and 0.83≦n₂/n₁≦0.89. Preferably, the optical film thickness of the low refractive index layer is 0.1λ₀ to 0.3λ₀.

### Calculation Example 3

In Calculation Example 3, the calculations were performed for the case where the low refractive index layer and the periodic structure layer are made of different materials, that is, the case where the refractive index n₂ of the low refractive index layer is different from the refractive index n₃ of the periodic structure layer.

In Calculation Example 3, the calculations were performed assuming the antireflection structural body having the structure shown in FIG. 1, as in the case with Calculation Example 1. The shape and arrangement of the projections were the same as those used in Calculation Example 1, and the refractive index of the substrate and the periodic structure layer was 1.8.

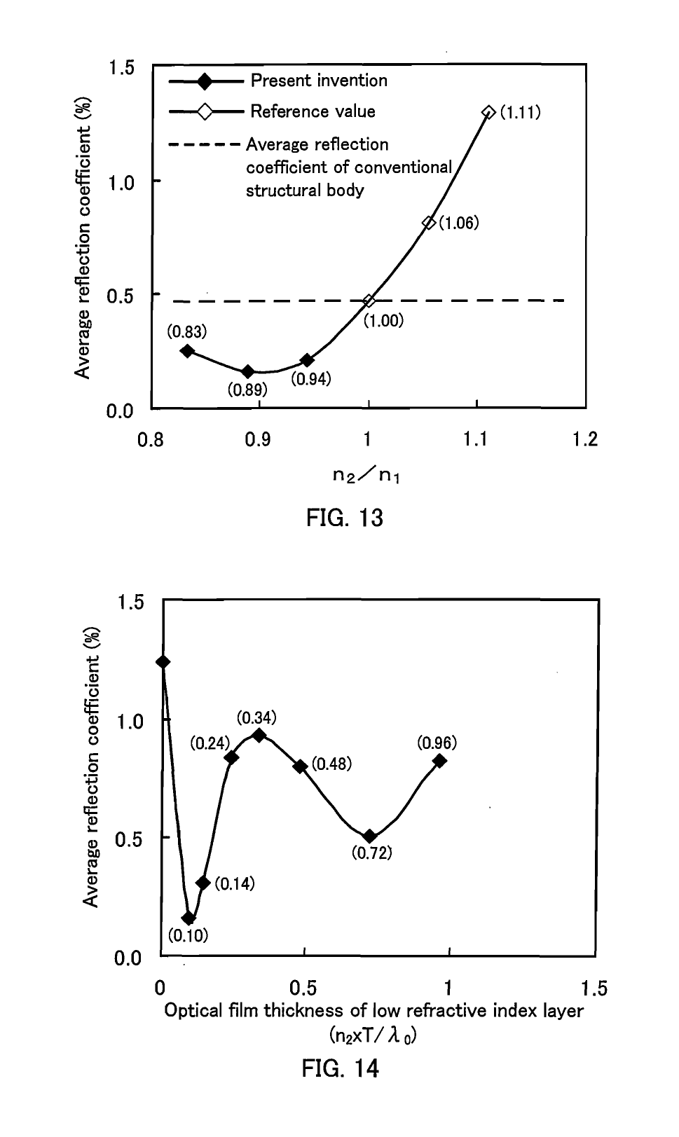

The results of the calculations are described below with reference to FIGS. 13 and 14.

FIG. 13 shows the average reflection coefficient of the structural body that changes with a change in the refractive index ratio (n₂/n₁) between the substrate and the low refractive index layer. In the calculations for obtaining the results shown in FIG. 13, the upper base W of the projections and the physical film thickness T of the low refractive index layer were optimized in a range of 40 to 60 nm and in a range of 10 to 40 nm, respectively, so as to minimize the average reflection coefficient of the assumed structural body.

FIG. 13 also indicates, as reference values, the results of the calculations obtained in the case of n₁≦n₂. FIG. 13 further indicates the results of the calculations performed for a conventional antireflection structural body (having an average reflection coefficient of 0.47%). In the assumed conventional structural body, the periodic structure layer and the substrate had the same refractive index (n₁=n₃=1.8), and the shape and arrangement of the projections were the same as those of the antireflection structural body of the present invention assumed as above. Numerical values in parentheses in FIG. 13 are the values of the ratio (n₂/n₁) at respective points.

As shown in FIG. 13, even in the case where the material of the low refractive index layer is different from that of the periodic structure layer, when the refractive index ratio (n₂/n₁) between the low refractive index layer and the substrate was 0.8≦n₂/n₁<1, the average reflection coefficient was lower than that of the conventional structural body. On the other hand, when the refractive index ratio (n₂/n₁) was 1 or more as indicated as the reference values, the average reflection coefficient was higher than that of the assumed conventional structural body.

Since the refractive index n₁ of the substrate is 1.8 in Calculation Example 3, the refractive index of the material that forms the low refractive index layer can be selected from a range of 1.44≦n₂<1.8.

As shown in FIG. 13, when the refractive index ratio (n₂/n₁) between the low refractive index layer and the substrate was 0.8≦n₂/n₁<1, the antireflection performance is improved compared with the conventional structural body. When the ratio (n₂/n₁) is 0.83≦n₂/n₁≦0.94, the antireflection performance is improved significantly compared with the conventional structural body. These ranges of n₂/n₁ values are particularly preferable when the refractive index n₁ of the substrate is 1.7 to 2.2, and further preferable when n₁ is 1.75 to 2.2. In the calculations for obtaining the results shown in FIG. 13, W and T were optimized in a range of 40 to 60 nm and in a range of 10 to 40 nm, respectively, in the cases of 0.8≦n₂/n₁<1 and 0.83≦n₂/n₁≦0.94.

As described in Calculation Example 1, when considering a method of actually forming the periodic structure layer and ease of manufacturing the antireflection structural body, the refractive index ratio (n₂/n₁) between the low refractive index layer and the substrate is preferably 0.89 or less, at which the structural body assumed in Calculation Example 3 exhibits the maximum antireflection performance. Specifically, the ratio (n₂/n₁) is preferably 0.8≦n₂/n₁≦0.89, and more preferably 0.83≦n₂/n₁≦0.89. These ranges of n₂/n₁ values are particularly preferable when the refractive index n₁ of the substrate is 1.7 to 2.2, and further preferable when n₁ is 1.75 to 2.2. In the calculations for obtaining the results shown in FIG. 13, W and T were optimized in a range of 40 to 60 nm and in a range of 10 to 40 nm, respectively, in the cases of 0.8≦n₂/n₁≦0.89 and 0.83≦n₂/n₁≦0.89.

Next, FIG. 14 shows a relationship between the optical film thickness of the low refractive index layer and the average reflection coefficient of the structural body of the present invention assumed in Calculation Example 3, with the refractive index ratio (n₂/n₁) between the substrate and the low refractive index layer fixed at 0.89, at which the structural body exhibits the maximum antireflection performance. In the calculations for obtaining the results shown in FIG. 14, the upper base W of the projections was optimized in a range of 40 to 80 nm so as to minimize the average reflection coefficient of the assumed structural body. The optical film thickness of the low refractive index layer was normalized by the center wavelength λ₀ (=600 nm) of incident light, as in the case with Calculation Example 1. Numerical values in parentheses in FIG. 14 are the optical film thickness values of the low refractive index layer at respective points.

As shown in FIG. 14, the average reflection coefficient of the structural body fluctuated in accordance with a change in the optical film thickness of the low refractive index layer. From the course of the fluctuation of the average reflection coefficient shown in FIG. 14, it is considered that in the structural body of the present invention, a reflected wave generated on the periodic structure layer interfered with a reflected wave generated at the interface between the low refractive index layer and the substrate. The results shown in FIG. 14 show that when the low refractive index layer has an optical thickness of 0.05λ₀ to 0.2λ₀, particularly high antireflection performance in suppressing reflection of visible light can be achieved in spite of its very small thickness. In the assumed structural body, 0.05λ₀ to 0.2λ₀ in the optical thickness of the low refractive index layer is equivalent to 20 to 80 nm in the physical film thickness T of that layer.

The same relationship between the average reflection coefficient of the structural body and the optical film thickness of the low refractive index layer also tends to be established in the case where the refractive index ratio (n₂/n₁) is in each of the above-mentioned ranges of 0.8≦n₂/n₁<1, 0.83≦n₂/n₁≦0.94, 0.8≦n₂/n₁≦0.89, and 0.83≦n₂/n₁≦0.89. Preferably, the optical film thickness of the low refractive index layer is 0.05λ₀ to 0.2λ₀.

An examination of the results of Calculation Examples 2 and 3 shows that the optical thickness of the low refractive index layer is preferably 0.05λ₀ to 0.3λ₀.

### Calculation Example 4

In Calculation Example 4, assuming the antireflection structural body having the structure shown in FIG. 1, as in the case with Calculation Example 1, the reflection coefficient thereof was calculated. The refractive index n₁ of the substrate of the structural body used for the calculations was 1.8, and the refractive index n₂ of the low refractive index layer was 1.6. The refractive index ratio (n₂/n₁) is 0.89. The shape and arrangement of the projections were the same as those used in Calculation Example 1.

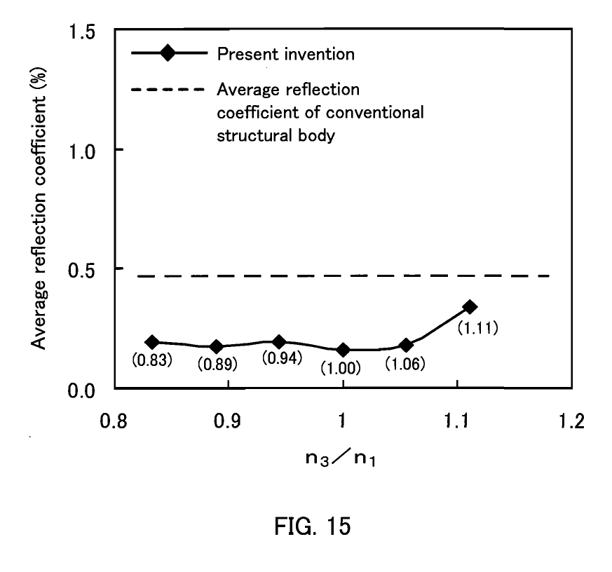

The results of the calculations are described below with reference to FIG. 15.

FIG. 15 shows the average reflection coefficient of the structural body that changes in accordance with a change in the refractive index ratio (n₃/n₁) between the substrate and the periodic structure layer. In the calculations for obtaining the results shown in FIG. 15, the upper base W of the projections and the physical film thickness T of the low refractive index layer were optimized in a range of 40 to 60 nm and in a range of 30 to 180 nm, respectively, so as to minimize the average reflection coefficient of the assumed structural body.

FIG. 15 also indicates the results of the calculations performed for a conventional antireflection structural body (having an average reflection coefficient of 0.47%). In the assumed conventional structural body, the periodic structure layer and the substrate had the same refractive index (n=1.8), and the shape and arrangement of the projections were the same as those of the antireflection structural body of the present invention assumed as above. Numerical values in parentheses in FIG. 15 are the values of the ratio (n₂/n₁) at respective points.

As shown in FIG. 15, it is found that the change in the refractive index of the periodic structure layer has little effect on the antireflection performance of the structural body of the present invention. The refractive index n₃ of the periodic structure layer may be higher or lower than the refractive index n₂ of the low refractive index layer. As shown in Calculation Example 4, in the antireflection structural body of the present invention, an arbitrary material can be selected as a material for forming the periodic structure layer (projections). Unlike the conventional structural body, the material of the periodic structure layer is not constrained by the refractive index of the substrate.

The average reflection coefficient of the antireflection structural body of the present invention can be reduced to 1% or less, further 0.5% or less, less than 0.47%, and less than 0.32%, depending on its structure. The above-mentioned average reflection coefficient of the antireflection structural body that exists in reality can be measured using a spectrophotometer.

Hereafter, a method of manufacturing the antireflection structural body of the present invention is described.

The antireflection structural body of the present invention can be manufactured by, for example, forming the low refractive index layer and the periodic structure layer on the substrate in this order. In the case where the low refractive index layer and the periodic structure layer are made of the same material, the antireflection structural body can be manufactured by forming a precursor layer on the substrate and forming the periodic structure layer partially in the precursor layer in its thickness direction. In this case, the remaining portion of the precursor layer is a low refractive index layer.

Any material may be used for the substrate as long as it has a property of transmitting light in a wavelength range to be used (typically visible light). For example, the substrate is made of an inorganic amorphous material such as glass, inorganic crystalline material, or resin. Specifically, various optical materials can be used as a substrate. Glass is, for example, soda lime glass, quartz glass, or an optical glass such as BK7.

Preferably, the low refractive index layer is a flat layer having a uniform film thickness. The low refractive index layer may be made of a material having a property of transmitting light (typically visible light) in the above wavelength range that is incident upon the antireflection structural body and having a lower refractive index than the material that forms the substrate. Such a material is, for example, an inorganic amorphous material, inorganic crystalline material, or resin. Specific examples of the material include magnesium fluoride (n_{d}=1.38) and calcium fluoride (n_{d}=1.43). In this case, the substrate may be made of a material having a refractive index of about 1.5, such as soda lime glass (n_{d}=1.52), BK7 (n_{d}=1.52), and quartz glass (n_{d}=1.46), or may be made of a material having a high refractive index of about 1.8 or more, such as flint-based glass like SF (n_{d}=1.7 to 1.9), lanthanum-based glass like LaSF or LF (n_{d}=1.7 to 1.9), chalcogenide glass (n_{d}=2.5), or an inorganic optical crystal like KTaO₃, LiNbO₃, or LiTaO₃ (n_{d}=2.2).

The difference (n₁=n₂) between the refractive index n₁ of the substrate and the refractive index n₂ of the low refractive index layer may exceed 0.1.

The low refractive index layer can be formed by a known method, for example, a vacuum film forming method such as an evaporation method and a sputtering method.

The periodic structure layer (projections) may be made of a material having a property of transmitting light (typically visible light) in the above wavelength range that is incident upon the antireflection structural body. Such a material is, for example, an inorganic amorphous material, inorganic crystalline material, or resin. Specifically, examples of the material include a low melting point glass, glass formed by a sol-gel method, organic-inorganic hybrid material, thermoplastic resin, thermosetting resin, ultraviolet (UV)-curing resin. As described above, in the antireflection structural body of the present invention, the material of the periodic structure layer is not particularly constrained by the refractive index.

Furthermore, as shown in the above calculation examples, the refractive index n₃ of the periodic structure layer may be higher or lower than the refractive index n₁ of the substrate. In the case where the refractive index n₃ of the periodic structure layer is lower than the refractive index n₁ of the periodic structure layer, the difference (n₁−n₃) between the refractive index n₁ of the substrate and the refractive index n₃ of the periodic structure layer may exceed 0.1.

The precursor layer can be formed by the same method as in the low refractive index layer.

The method of forming the periodic structure layer is not particularly limited, and it can be formed, for example, in the following manner. First, a film made of a material to be used as a periodic structure layer (projections) or a film to be a material that forms the periodic structure layer eventually (preferably, a flat film having a uniform film thickness) is formed on the low refractive index layer. This film may be formed in the same manner as in the formation of the low refractive index layer. Next, the formed film may be processed to obtain the periodic structure layer.

The processing method is not particularly limited as long as it is a method capable of obtaining the shape and arrangement of the projections with high precision. A specific processing method is, for example, a photolithography method including a dry etching process, a press transfer method, or the like. In the case where the low refractive index layer and the periodic structure layer are formed simultaneously, the precursor layer also may be processed in the same manner.

The photolithography method can be performed, for example, in the following manner. After a film to be a periodic structure layer is coated with a photoresist, the photoresist is subjected to exposure and development so as to form a resist pattern. Next, after the film is subjected to dry etching, the resist pattern is removed. Thus, the periodic structure layer (projections) is formed.

In this case, if a material having a higher etching rate than that of the low refractive index layer serving as a base layer is used as a material of the periodic structure layer, over-etching of the low refractive index film can be prevented effectively. This makes it easier to control the etching amount, and thus easier to form projections having a shape and an arrangement as designed. As one example, in the case where the antireflection structural body of the present invention is formed using BK7 (n_{d}=1.52) as a substrate, for example, magnesium fluoride (n_{d}=1.38) and silica (n_{d}=1.45) can be used as the materials of the low refractive index layer and the periodic structure layer. However, since the etching rate of silica is higher than that of magnesium fluoride, the use of silica as the material makes it easier to control the etching amount.

As a press transfer method, for example, a nanoimprint method can be used.

The nanoimprint method is a method in which a die called a stamper or a mold is pressed against a material to be shaped that has been applied on a substrate so as to transfer a pattern of a shape. This method includes a heat curing method and a UV curing method. In the heat curing method, a material to be shaped that has been formed on a substrate is heated to its glass transition temperature or higher, and a die is pressed against the material in a softened state. Then, the substrate is cooled and released from the die. In the UV curing method, a liquid material to be shaped is applied onto a substrate, and the substrate is irradiated with ultraviolet rays while a die is pressed against the material so as to cure the material, and then released from the die.

The use of the nanoimprint method makes it possible to obtain nanometer scale projections and an arrangement thereof with high precision. This method also makes it possible to obtain various shapes of projections and various arrangements thereof compared with the photolithography method. Furthermore, since this nanoimprint method is very superior in mass productivity, the manufacturing cost of the antireflection structural body can be reduced.

Examples of the material to be used in the nanoimprint method include resins such as a fluorinated thermoplastic resin and polycarbonate, metal oxide sols or gels used for forming glass by a sol-gel method, and inorganic materials such as a low melting point glass.

The method of forming the periodic structure layer is not limited to the above-mentioned methods. For example, the periodic structure layer can be formed by a method using a transfer film, or the like.

The invention may be embodied in other forms without departing from the spirit or essential characteristics thereof. The embodiments disclosed in this specification are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

The present invention can provide an antireflection structural body that exhibits high antireflection performance and provides a high degree of freedom in selecting a material to be used for a periodic structure layer.

The antireflection structural body of the present invention can be applied to various applications depending on the type and shape of the substrate. For example, the substrate may be a lens, a prism, or the like. In this case, the antireflection structural body of the present invention is an optical element having a surface with reduced reflection of incident light.

1. An antireflection structural body comprising: a substrate having a property of transmitting light in a wavelength range to be used; and an antireflection layer arranged on the substrate,
wherein the antireflection layer has a periodic structure of an arrangement of projections,
the arrangement period of the projections in the antireflection layer is not greater than a shortest wavelength in the wavelength range,
the antireflection structural body further comprises, between the substrate and the antireflection layer, a low refractive index layer having a lower refractive index than a refractive index of the substrate,
a ratio (n₂/n₁) between the refractive index n₁ of the substrate and the refractive index n₂ of the low refractive index layer is 0.8≦n₂/n₁≦0.89,
a material that forms the low refractive index layer is different from a material that forms the antireflection layer, and
the low refractive index layer has an optical thickness of 0.05λ₀ to 0.2λ₀, where λ₀ is a center wavelength of the wavelength range.

2. (canceled)

3. (canceled)

4. (canceled)

5. (canceled)

6. (canceled)

7. (canceled)

8. The antireflection structural body according to claim 1, wherein a ratio (H/P) between a height H of the projections and the arrangement period P of the projections in the antireflection layer is 0.8≦H/P.

9. The antireflection structural body according to claim 1, wherein a ratio (B/P) between the arrangement period P of the projections in the antireflection layer and a length B of a bottom surface of the projections in their periodic direction is 0.7≦B/P≦1.

10. The antireflection structural body according to claim 9, wherein the ratio (B/P) is 1.

11. The antireflection structural body according to claim 8, wherein the projections have a cross section of a trapezoid in a thickness direction of the antireflection layer.

12. The antireflection structural body according to claim 11, wherein a ratio (W/P) between the arrangement period P of the projections in the antireflection layer and an upper base W of the trapezoid is W/P≦0.7.

13. (canceled)
